(19) United States
(12) Patent Application Publication
(10) Pub. No.: US 2025/0265721 A1
(43) Pub. Date: Aug. 21, 2025

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Yuichi KAGEYAMA, Kanagawa (JP)

(21) Appl. No.: 19/042,032

(22) Filed: Jan. 31, 2025

(30) Foreign Application Priority Data
Feb. 16, 2024 (JP) 2024-022202

(51) Int. Cl. G06T 7/20; G06T 7/60; G06V 10/25

(52) U.S. Cl. CPC G06T 7/20; G06T 7/60; G06V 10/25; G06T 2207/20132; G06V 2201/07

(57) ABSTRACT

An information processing apparatus comprising: one or more memories storing instructions; and one or more processors executing the instructions to: execute tracking-target specification processing of specifying, as a tracking target, a target to be tracked that is included in an image; execute local-region specification processing of specifying, within the image, a local region that includes at least part of a detection target that is included in the tracking target; execute cropping-region determination processing of, based on size information of the local region, determining size information of a cropping region for cropping the tracking target from the image; and execute cropping processing of generating a cropped image by cropping the image based on the cropping region.

### BACKGROUND OF THE INVENTION

### Field of the Invention

The present invention relates to an information processing apparatus, an information processing method, and a non-transitory computer-readable storage medium.

### Description of the Related Art

In recent years, there is known a technique of cutting out (hereinafter “cropping”) partial regions including a target to be tracked (hereinafter “tracking target”) that is included in images, and tracking the tracking target using images of the partial regions (hereinafter “cropped images”).

Japanese Patent Laid-Open No. 2021-141421 discloses a technique in which, in order to determine one cropped image for executing a plurality of recognition tasks, size information of the whole body of the main subject and information other than that of the main subject are used. In the technique disclosed in Japanese Patent Laid-Open No. 2021-141421, an image is cropped to generate a cropped image in which a partial region including a subject is cut out from the entire image.

### SUMMARY OF THE INVENTION

However, according to the technique disclosed in Japanese Patent Laid-Open No. 2021-141421, cropping is performed using as a reference the size of the whole tracking target, which is readily affected by a change in posture of the tracking target, upon determining cropped images, and thus the size of the regions that are cropped readily changes when the posture of the tracking target changes, resulting in the cropped images being unstable.

In view of this, the present invention provides a technique that allows stable cropped images to be generated.

According to one aspect of the present disclosure, there is provided an information processing apparatus comprising: one or more memories storing instructions; and one or more processors executing the instructions to: execute tracking-target specification processing of specifying, as a tracking target, a target to be tracked that is included in an image; execute local-region specification processing of specifying, within the image, a local region that includes at least part of a detection target that is included in the tracking target; execute cropping-region determination processing of, based on size information of the local region, determining size information of a cropping region for cropping the tracking target from the image; and execute cropping processing of generating a cropped image by cropping the image based on the cropping region.

According to another aspect of the present disclosure, there is provided an information processing method comprising: specifying, as a tracking target, a target to be tracked that is included in an image; specifying, within the image, a local region that includes at least part of a detection target that is included in the tracking target; based on size information of the local region, determining size information of a cropping region for cropping the tracking target from the image; and generating a cropped image by cropping the image based on the cropping region.

According to another aspect of the present disclosure, there is provided a non-transitory computer-readable storage medium storing a computer program that, when read and executed by a computer, causes the computer to function as: a tracking-target specification unit configured to specify, as a tracking target, a target to be tracked that is included in an image; a local-region specification unit configured to specify, within the image, a local region that includes at least part of a detection target that is included in the tracking target; a cropping-region determination unit configured to, based on size information of the local region, determine size information of a cropping region for cropping cutting out the tracking target from the image; and a cropping unit configured to generate a cropped image by cropping the image based on the cropping region.

Further features of the present invention will become apparent from the following description of exemplary embodiments (with reference to the attached drawings).

### BRIEF DESCRIPTION OF THE DRAWINGS

FIG. 1 is a hardware configuration diagram of an information processing apparatus in embodiments.

FIG. 2 is a functional block diagram for describing functions of the information processing apparatus in first to fourth embodiments.

FIG. 3A is a diagram of time-series images for describing the first and second embodiments.

FIG. 3B is a diagram of the time-series images for describing the first and second embodiments.

FIG. 3C is a diagram of the time-series images for describing the first and second embodiments.

FIG. 3D is a diagram of the time-series images for describing the first and second embodiments.

FIG. 3E is a diagram of the time-series images for describing the first and second embodiments.

FIG. 4 is a diagram illustrating a flowchart of recognition processing in the first to fourth embodiments.

FIG. 5A is a diagram illustrating a flowchart of cropping-region determination processing in the first embodiment.

FIG. 5B is a diagram illustrating a flowchart of cropping-region determination processing in the second embodiment.

FIG. 6A is a diagram of pre-registered information in the first embodiment.

FIG. 6B is a diagram of pre-registered information in the second embodiment.

FIG. 6C is a diagram of pre-registered information in the third embodiment.

FIG. 6D is a diagram of pre-registered information in the fourth embodiment.

FIG. 7A is a diagram of time-series images for describing the third and fourth embodiments.

FIG. 7B is a diagram of the time-series images for describing the third and fourth embodiments.

FIG. 7C is a diagram of the time-series images for describing the third and fourth embodiments.

FIG. 7D is a diagram of the time-series images for describing the third and fourth embodiments.

FIG. 7E is a diagram of the time-series images for describing the third and fourth embodiments.

FIG. 7F is a diagram of the time-series images for describing the third and fourth embodiments.

FIG. 7G is a diagram of the time-series images for describing the third and fourth embodiments.

FIG. 7H is a diagram of the time-series images for describing the third and fourth embodiments.

FIG. 8 is a diagram illustrating a flowchart of cropping-region determination processing in the third embodiment.

FIG. 9 is a diagram illustrating a flowchart of cropping-region determination processing in the fourth embodiment.

FIG. 10 is a diagram for describing a configuration of information processing apparatuses in a fifth embodiment.

FIG. 11A is a diagram of time-series images for describing the fifth embodiment.

FIG. 11B is a diagram of the time-series images for describing the fifth embodiment.

FIG. 11C is a diagram of the time-series images for describing the fifth embodiment.

FIG. 11D is a diagram of the time-series images for describing the fifth embodiment.

FIG. 11E is a diagram of the time-series images for describing the fifth embodiment.

FIG. 11F is a diagram of the time-series images for describing the fifth embodiment.

FIG. 12A is a diagram illustrating the entire flowchart in the fifth embodiment.

FIG. 12B is a diagram illustrating a flowchart of cropping-region determination processing in the fifth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment: Cropping Method Involving Use of Local Portion where Rate of Fluctuation in Size in Response to Change in Posture is Low

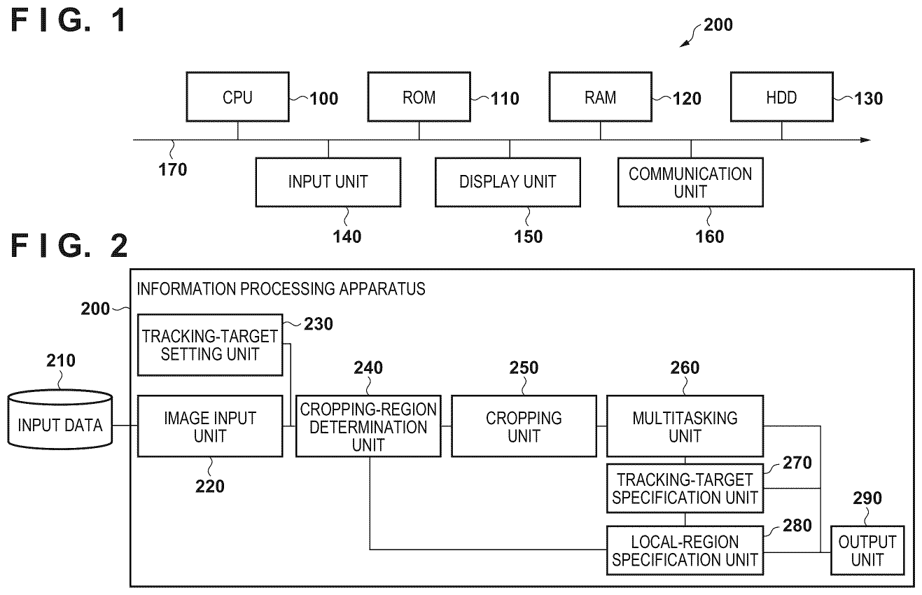

FIG. 1 illustrates an example of a hardware configuration diagram of an information processing apparatus 200. The information processing apparatus 200 may be a so-called computer. The information processing apparatus 200 includes a CPU 100, a ROM 110, a RAM 120, an HDD 130, an input unit 140, a display unit 150, a communication unit 160, and a bus 170. The CPU 100, the ROM 110, the RAM 120, the HDD 130, the input unit 140, the display unit 150, and the communication unit 160 are connected via the bus 170 so as to be capable of transmitting and receiving information to and from one another.

The CPU (abbreviation of central processing unit) 100 is a central computation processing device. The information processing apparatus 200 may include, in place of or in addition to the CPU 100, one or more other processors such as a micro-processing unit (MPU), a graphics processing unit (GPU), and/or a quantum processing unit (QPU). The CPU 100 executes computation, logic determination, and the like for various types of processing. For example, the CPU 100 realizes various functions and executes various types of processing by reading one or more programs stored in the ROM 110 and/or the HDD 130 and expanding the programs to the RAM 120. Furthermore, some or all functions of the information processing apparatus 200 may be realized by one or more circuits such as an application specific integrated circuit (ASIC) and/or a field programmable gate array (FPGA).

The ROM (abbreviation of read-only memory) 110 is a non-volatile memory. The ROM 110 stores control programs such as an operating system (OS).

The RAM (abbreviation of random access memory) 120 is used as the primary memory and a temporary storage area, such as a work area, of the CPU 100.

The HDD (hard disk drive) 130 is a large capacity non-volatile storage device. The HDD 130 stores electronic data, programs, and data necessary for program execution according to the present embodiment. The information processing apparatus 200 may include, in place of or in addition to the HDD 130, one or more external storage devices that function in a similar manner as the HDD 130. Here, for example, the external storage devices may be realized by a medium (recording medium) and an external storage drive for realizing access to the medium. Flexible disks (FDs), CD-ROMs, DVDs, USB memories, MOs, flash memories, etc., are known as examples of such a medium. Furthermore, the external storage devices may be a server device connected via a network, etc.

The input unit 140 receives input from a user and transfers the input to the CPU 100. The input unit 140 includes a mouse, a keyboard, a touch panel, and/or the like.

Based on image data acquired from the CPU 100 or the like, the display unit 150 displays images of various types of data, processing results, etc., to the user. The display unit 150 is formed from a display device such as a liquid crystal display or an organic electroluminescence (EL) display. The term “image” may be used as a term encompassing a still image, a moving image, an image that is one frame of a moving image, a video, and data of such forms of images.

The communication unit 160 relays communication with other devices. Thus, the information processing apparatus 200 communicates data with other devices via the communication unit 160. The information processing apparatus 200 may receive user instructions from other devices via the communication unit 160, and may output processing results, etc., to other devices via the communication unit 160.

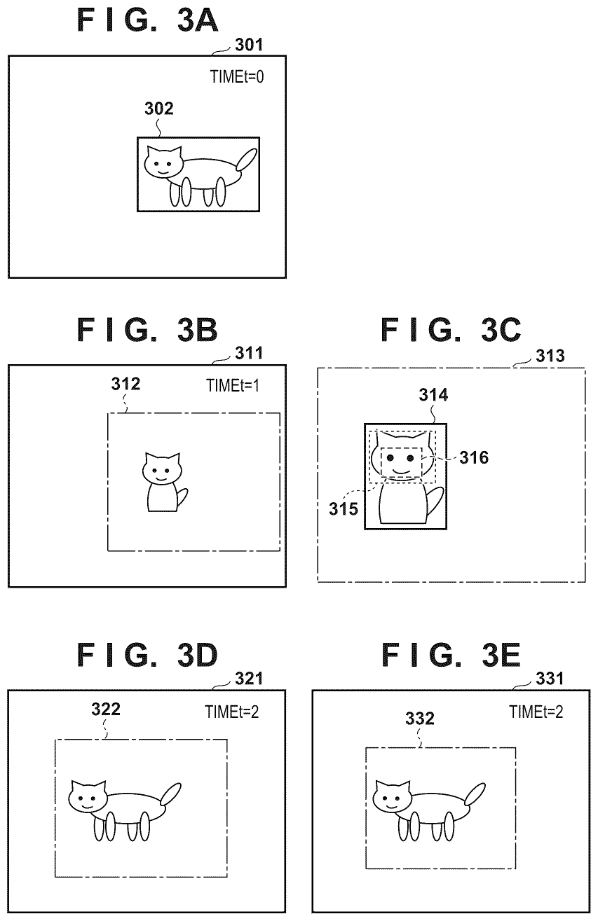

FIG. 2 is a functional block diagram for describing the functions of the information processing apparatus 200 according to the present embodiment. A configuration of the present embodiment will be described with reference to FIG. 2. Note that the configuration will only be outlined here, and will be described in detail later. The information processing apparatus 200 functions as an image input unit 220 a tracking-target setting unit 230, a cropping-region determination unit 240, a cropping unit 250, a multitasking unit 260, a tracking-target specification unit 270, a local-region specification unit 280, and an output unit 290. For example, the CPU 100 realizes the functions of the image input unit 220, the tracking-target setting unit 230, the cropping-region determination unit 240, the cropping unit 250, the multitasking unit 260, the tracking-target specification unit 270, the local-region specification unit 280, and the output unit 290 by reading and executing one or more programs stored in the ROM 110 and/or the HDD 130.

Input data 210 indicates data of a captured image or an image group including a plurality of captured images. For example, the input data 210 includes a plurality of time-series images obtained from an image-capturing device such as a digital camera, a surveillance camera, or the like.

The image input unit 220 receives one or more images input as the input data 210. For example, the input data 210 is a moving image in which a plurality of frame images continue in time series.

The tracking-target setting unit 230 sets at least one of the type, the in-image position, and the size, which is indicated by a pixel count or the like, of a tracking target that is a target to be tracked in the initial frame of the input data 210. For example, the tracking target may be of one of the following types: a person; an animal such as a cat or a dog; or a car or the like.

From an image transferred from the image input unit 220, the cropping-region determination unit 240 determines a cropping region for cropping the tracking target. Specifically, the cropping-region determination unit 240 determines size information of the cropping region based on size information of a local region that includes at least part of a detection target that is included in the tracking target. Size information is information relating to the size of an in-image region (local region), and may be at least one of: a pixel count within the region; and vertical and horizontal lengths of the region. The detection target is part of the tracking target, and, in the case of an animal for example, includes the head, face, or the like. There may be a plurality of detection targets. For example, the detection targets may include the head, face, feet, hands, etc. If a plurality of types of detection targets are detected, the cropping-region determination unit 240 may, in accordance with the later-described priority ranks, select a detection target for determining the size information of the cropping region from among the plurality of types of detection targets. In this case, the cropping-region determination unit 240 may determine the size information of the cropping region based on size information of a local region of the selected detection target. The cropping-region determination unit 240 may determine the position, etc., of the cropping region as well as the size information.

The cropping unit 250 cuts out a part of (crops) the image transferred from the image input unit 220 based on the cropping region determined by the cropping-region determination unit 240. Thus, the cropping unit 250 generates a cropped image that includes the tracking target and that is to be used by the multitasking unit 260.

The multitasking unit 260 executes a plurality of recognition tasks on the cropped image generated by the cropping unit 250. In the present embodiment, description is provided taking a cat whole-body detector, a cat head detector, and a cat face detector as examples of the plurality of recognition tasks. For example, various models including convolutional neural networks, vision transformers (ViTs), and support vector machines (SVMs) combined with feature extractors are conceivable as recognition models to be used in the executed recognition tasks. The present embodiment is not limited to the above-described forms; nevertheless, description is provided in the present embodiment regarding that the multitasking unit 260 is a CNN.

From detection results obtained from the multitasking unit 260, the tracking-target specification unit 270 specifies, as a tracking target, a target to be tracked included in the image. The tracking-target specification unit 270 specifies the tracking target from degrees of similarity between feature information of the tracking target obtained from the tracking-target setting unit 230 and feature information of the detection results obtained from the multitasking unit 260.

The local-region specification unit 280 specifies a local region for determining size information of a cropping region. Specifically, the local-region specification unit 280 specifies, in the image, a local region that includes at least part of a detection target that is included in the tracking target specified by the tracking-target specification unit 270. Note that the image in which the local region is specified may be the cropped image. That is, the local-region specification unit 280 may specify a local region in the image using the image or the cropped image. For example, if the tracking target is a cat, and the whole body, the head, and the face of the cat are detection targets, the local-region specification unit 280 specifies, for each detection target, a local region in the image that includes at least part of the detection target. The local-region specification unit 280 transfers, to the cropping-region determination unit 240, information about the one or more local regions that have been specified. The information about the local regions is used to determine a cropping region in the next frame.

The output unit 290 outputs results obtained from the multitasking unit 260, the tracking-target specification unit 270, and the local-region specification unit 280. In such a manner, the information processing apparatus 200 can accurately track a tracking target by processing an input scene sequentially in time.

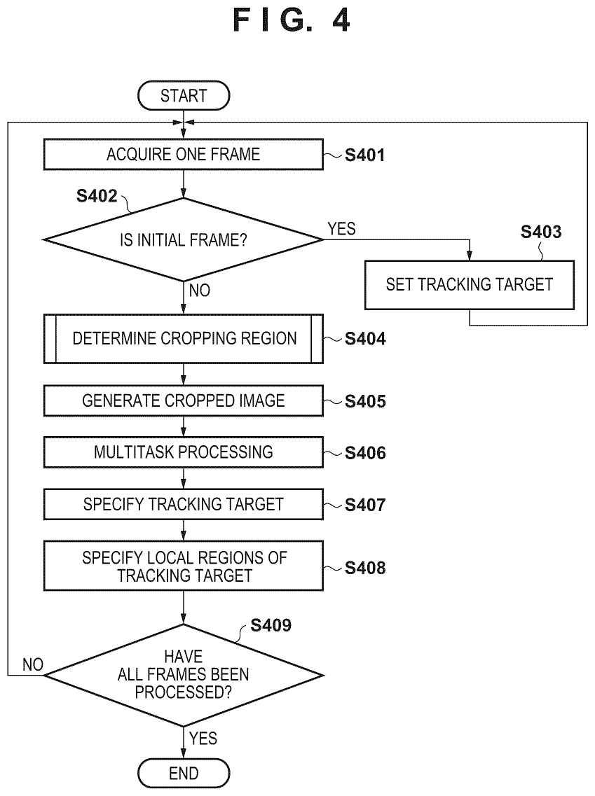

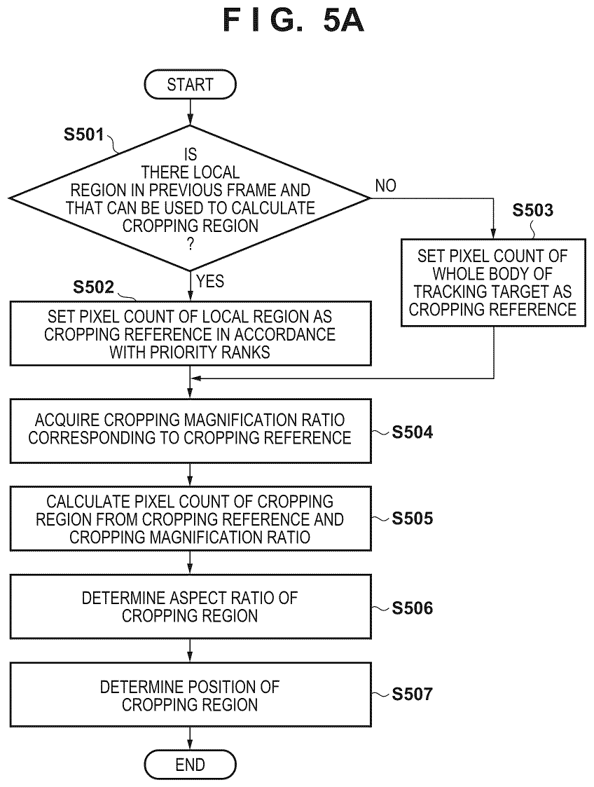

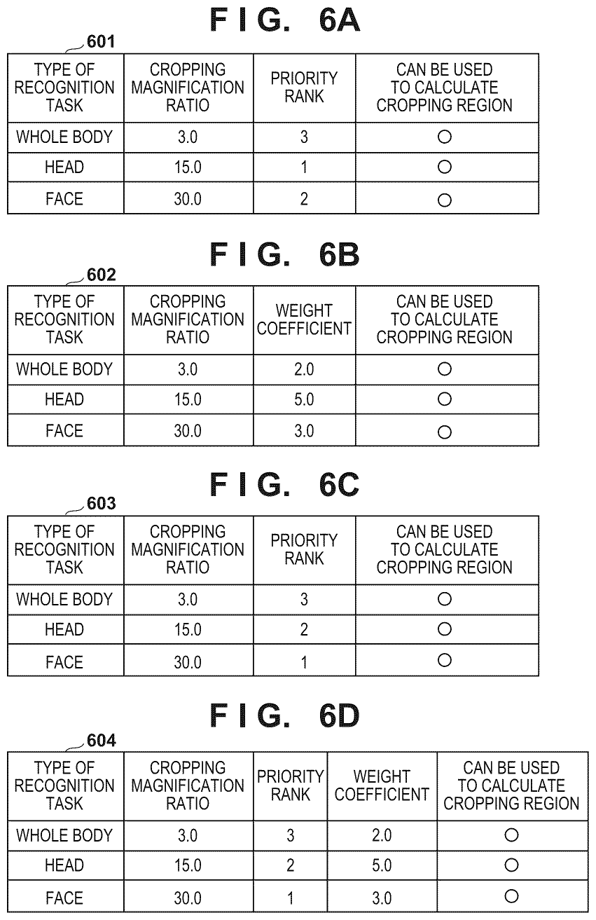

As an example in the present embodiment, FIGS. 3A to 3E illustrate time-series images in a case in which a cat is being tracked. Furthermore, FIG. 4 is a flowchart of recognition processing in the present embodiment. Hereinafter, flowcharts are realized by the CPU 100 executing a control program. FIG. 6A illustrates pre-registered information in the present embodiment. The pre-registered information is stored in the HDD 130, and, in the present embodiment, the information processing apparatus 200 can refer to the information, as necessary. The pre-registered information may be read from the HDD 130 and expanded to the RAM 120.

In the following, processing in the present embodiment will be described in detail with reference to FIG. 4.

In step S401, the image input unit 220 acquires an image of one frame that is input as input data 210. Here, the image input unit 220 acquires an image 301 illustrated in FIG. 3A. The image 301 in FIG. 3A is an image of the initial frame at time t=0. In the image 301, a cat is walking toward the left.

In step S402, the image input unit 220 determines whether or not the image in the acquired input data 210 is the initial frame. If image 301 is the initial frame at time t=0, the image input unit 220 determines that the image is the initial frame and advances to step S403.

In step S403, the tracking-target setting unit 230 sets a tracking target based on the image of the initial frame. Here, in step S403, the tracking-target setting unit 230 sets the cat as the tracking target, and also sets the position and the size of the tracking target. Any method may be adopted as the method for setting the tracking target. The tracking-target setting unit 230 may set the tracking target according to various methods; e.g., the tracking-target setting unit 230 may set the tracking target by receiving a touch on a camera screen or a voice operation by the user, etc., or by using a recognition result from a recognition processing unit of the camera, etc. In the present embodiment, the tracking-target setting unit 230 sets the whole body of the cat as a tracking-target region 302 as illustrated in FIG. 3A. Once the tracking-target setting unit 230 has set the tracking target, the image input unit 220 performs the processing in step S401 again.

In step S401, the image input unit 220 acquires an image 311 illustrated in FIG. 3B. Here, the image 311 is an image of the cat at time t=1. In the image 311, the cat that was walking toward the left has stopped.

In step S402, because the image 311 is a frame subsequent to the initial frame, the image input unit 220 determines that the image 311 is not the initial frame and moves on to cropping-region determination processing in step S404.

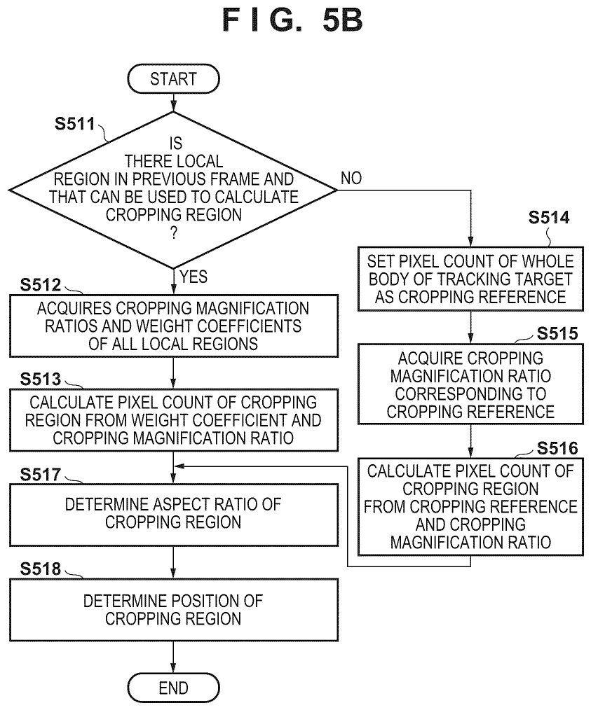

FIG. 5A illustrates a detailed flow of the cropping-region determination processing in step S404 executed by the cropping-region determination unit 240 in the first embodiment. The cropping-region determination unit 240 executes the processing in step S404, and the processing in steps S501 to S507 describing step S404 in detail.

In step S501, the cropping-region determination unit 240 determines whether or not there is a local region that has been detected in the previous frame (i.e., the frame at the previous time) and that can be used to calculate a cropping region. At time t=1, because the local-region specification processing to be executed in later-described step S408 has not been executed yet, the cropping-region determination unit 240 determines that there is no local region (NO in the determination in step S501), and moves on to the processing in step S503.

In step S503, the cropping-region determination unit 240 sets, as a cropping reference, the pixel count of the whole body of the tracking target set by the tracking-target setting unit 230.

Here, a cropping reference is size information of the tracking-target region in an image, and is information for calculating the size (pixel count) of a cropping region. Size and pixel count are examples of size information. The cropping-region determination unit 240 can determine a cropping region by using a cropping reference and a later-described cropping magnification ratio. In the present embodiment, description is provided regarding that a cropping reference is a pixel count; however, this is not necessarily the case, and any kind of information relating to the size of the tracking target may be used. For example, the cropping-region determination unit 240 may use, as a cropping reference, size information such as the length of the long sides, the length of the short sides, or the lengths of the diagonals of a rectangular frame indicating a target region. At time t=1, the cropping-region determination unit 240 determines a cropping region by multiplying a cropping magnification ratio and the pixel count of the whole body of the tracking target (i.e., the cropping reference).

In step S504, the cropping-region determination unit 240 acquires a cropping magnification ratio corresponding to the cropping reference. The cropping magnification ratio is a preset magnification ratio by which the cropping reference is to be multiplied, and can be set for each type of cropping reference (e.g., for each detection target). FIG. 6A illustrates pre-registered information 601 that is set in advance in the present embodiment. In the pre-registered information 601, a cropping magnification ratio is determined for each detection target (type of recognition task). It is indicated that the cropping magnification ratio when the whole body is selected as the cropping reference is 3.0×, the cropping magnification ratio when the head is selected as the cropping reference is 15.0×, and the cropping magnification ratio when the face is selected as the cropping reference is 30.0×. Accordingly, due to having set the pixel count of the whole body of the tracking target as the cropping reference in step S503, the cropping-region determination unit 240 selects and acquires, as the cropping magnification ratio in step S504, 3.0× associated with the whole body from the pre-registered information 601 illustrated in FIG. 6A. Furthermore, in the present embodiment, the pixel count of the tracking-target region 302 set by the tracking-target setting unit 230 is used as the pixel count of the whole body of the tracking target in the present embodiment; however, there is no limitation to this, and a result from the whole-body detector of the multitasking unit 260 may be used.

In step S505, the cropping-region determination unit 240 calculates the pixel count of the cropping region from the cropping reference and the cropping magnification ratio. Specifically, the cropping-region determination unit 240 calculates, as the pixel count of the cropping region, a product of the pixel count of the whole body of the tracking target set as the cropping reference and the cropping magnification ratio determined in step S504.

In step S506, the cropping-region determination unit 240 determines the aspect ratio of the cropping region. In the present embodiment, description is provided regarding that the aspect ratio is 4:3; however, there is no limitation to this. For example, the cropping-region determination unit 240 may determine the aspect ratio in accordance with the cropping region, or may adopt a predetermined aspect ratio.

In step S507, the cropping-region determination unit 240 determines the position of the cropping region. In the present embodiment, the cropping-region determination unit 240 determines the center of the tracking target as the position of the cropping region. Note that the position of the cropping region does not necessarily have to be the center of the tracking target, and any position determination method may be used. Thus, the cropping-region determination unit 240 determines a cropping region 312 illustrated in FIG. 3B. The processing leaves the detailed flow of step S404, and advances to step S405.

In step S405, the cropping unit 250 generates a cropped image 313. For example, the cropping unit 250 crops the image 311 using the cropping region 312 determined as a result of step S404, and resizes the resultant image. In the present embodiment, description is provided regarding that the image size after the resizing is QVGA (320 pixels×240 pixels); however, the image size is not limited to this. As a result of the above-described processing, the cropping unit 250 generates the cropped image 313 illustrated in FIG. 3C.

In step S406, the multitasking unit 260 executes multitask processing on the cropped image 313 in FIG. 3C. In the present embodiment, description is provided taking the cat whole-body detector, the cat head detector, and the cat face detector as an example of the multitask processing executed by the multitasking unit 260; however, there is no limitation to this. For example, the multitasking unit 260 may execute, in place of or in addition to the above-described detectors, a pupil detector, a tracking-target tracking function, etc., as the multitask processing. A whole-body detection result 314, a head detection result 315, and a face detection result 316 illustrated in FIG. 3C are the results of the detection by the multitasking unit 260 at time t=1.

In step S407, the tracking-target specification unit 270 specifies a tracking target from among the detection results from the multitasking unit 260. In the present embodiment, the tracking-target specification unit 270 compares the feature amounts of the individual detection results and the tracking-target region 302, and determines the detection result having the closest feature amount as the tracking target. The specification of the tracking target does not necessarily have to involve comparison of feature amounts, and any method may be adopted as long as a detection result can be determined as the tracking target. At time t=1, the tracking-target specification unit 270 specifies the whole-body detection result 314 as the tracking target.

In step S408, the local-region specification unit 280 specifies one or more local regions of the tracking target from among the detection results from the multitasking unit 260. In the present embodiment, the local-region specification unit 280 specifies local regions using the distance from the center position of the whole-body detection result 314 in FIG. 3C, which has been specified by the tracking-target specification unit 270 as the tracking target. The specification of local regions does not necessarily have to involve the use of distance information. At time t=1, the local-region specification unit 280 specifies the head detection result 315 and the face detection result 316 as local regions. Here, the whole-body detection result 314 has been specified as the tracking target, and thus is not adopted as a local region for determining a cropping region. The regions of the head detection result 315 and the face detection result 316 are an example of a plurality of local regions of a plurality of different types of detection targets of a tracking target.

In step S409, it is determined whether or not all frames have been processed. Because not all frames have been processed at time t=1, processing returns to step S401 and the processing at time t=2 is performed.

In step S401, the image input unit 220 acquires an image 321 in FIG. 3D. The image 321 is an image of the cat at time t=2. In the image 321, the cat that was not moving in the previous frame has started to move again toward the left. Subsequently, the cropping-region determination unit 240 executes the processing in step S404 again after the image input unit 220 executes the processing in step S402.

In step S501 in FIG. 5A, which illustrates the detailed flow of step S404, the cropping-region determination unit 240 determines whether or not there is a local region that has been detected in the previous frame and that can be used to calculate a cropping region. The cropping-region determination unit 240 detected the head detection result 315 and the face detection result 316 in the previous frame at time t=1. Furthermore, because the cropping-region determination unit 240 can use all of the information registered in the pre-registered information 601 to calculate a cropping region in the present embodiment, the cropping-region determination unit 240 moves on to the processing in step S502.

In step S502, the cropping-region determination unit 240 sets the pixel count of a local region as a cropping reference in accordance with priority ranks in the pre-registered information 601. Here, if there are a plurality of types of local regions, the cropping-region determination unit 240 selects a detection target in accordance with the priority ranks, and sets a local region of the selected detection target as the cropping reference. Specifically, among the two local regions here, i.e., the head detection result 315 and the face detection result 316, the local region having the higher priority rank is the head detection result 315, with reference to the pre-registered information 601. Accordingly, in step S502, the cropping-region determination unit 240 sets the pixel count of the head detection result 315 as the cropping reference.

Here, the priority ranks of the cropping references in the pre-registered information 601 are determined in advance in consideration of the “rate of fluctuation in size in response to change in posture”. Taking the cat in the present embodiment as an example, between the walking and stopping states, the fluctuation in size of the whole body is great but the fluctuation in size of the head is small. Thus, by setting the head as a cropping reference, the cropping-region determination unit 240 can reduce the fluctuation of a cropping region in response to a change in posture. The fluctuation in size of the face in response to a change in posture is greater than that of the head but smaller than that of the whole body. Thus, the priority rank of the head, the priority rank of the face, and the priority rank of the whole body are set to first, second, and third, respectively.

The cropping-region determination unit 240 acquires 15.0× as a cropping magnification ratio from the pre-registered information 601 in step S504, and calculates the pixel count of the cropping region in step S505. Subsequently, the cropping-region determination unit 240 determines a cropping region 322 in FIG. 3D by executing the processing in steps S506 and S507.

In step S405, the cropping unit 250 generates a cropped image using the cropping region 322. Subsequently, the processing from step S406 to step S409 is executed, and the series of processing is concluded.

In the present embodiment, a cropping reference and a cropping magnification ratio can be determined in consideration of the “rate of fluctuation in size in response to change in posture” as described above. In the case of a curled-up cat, etc., an extremely small cropping region would be determined if a region that is readily affected by a change in posture were set as the cropping reference. Because the cropping region is determined using information about the previous frame, a part or the entirety of the cat may exceed the boundaries of the cropping region in a case such as that in which the cat moves abruptly in the current frame if the cropping region were small. If such a situation occurs, the cat would exceed the boundaries of the cropped image, and it would be impossible to execute the multitask processing correctly.

In the present embodiment, processing is executed by setting, as priority ranks in the pre-registered information, the knowledge that the size of a cat's whole body fluctuates significantly depending on posture, and the size of a cat's head does not fluctuate much depending on posture.

That is, in the present embodiment, size information of a cropping region is determined based on size information of the head or the like, which is not readily affected by a change in posture of the tracking target. Thus, in the present embodiment, stable cropped images can be generated because the size of cropping regions is not readily affected by changes in posture of the tracking target. Due to this, in the present embodiment, the tracking target can be suppressed from exceeding the boundaries of cropping regions, whereby the performance of the multitask processing including processing of a plurality of recognition tasks can be stabilized and the accuracy of the detection tasks performed on the detection targets can also be stabilized.

In the present embodiment, a detection target to be used to determine size information of a cropping region is selected based on the priority ranks set in advance for the whole body, the head, and the face, which are the plurality of detection targets. Furthermore, in the present embodiment, the size information of the cropping region is determined based on the size information of the local region of the selected detection target. Thus, in the present embodiment, cropping regions can be stabilized with greater certainty. Furthermore, in the present embodiment, even if a detection target having the highest priority rank is not detected, size information of a cropping region can be determined based on size information of a local region of a detection target that is next least affected by a change in posture of the tracking target.

### Second Embodiment: Calculation of Cropping Region Using Results of Plurality of Recognition Tasks

In the second embodiment, a method for determining a cropping region using results of a plurality of recognition tasks will be described, taking as an example a case in which a cat is walking, similarly to the first embodiment. In the present embodiment, the local-region specification unit 280 specifies a plurality of local regions. For example, the local-region specification unit 280 specifies a local region from each of a plurality of detection targets including the head, the face, etc., and consequently specifies a plurality of local regions. The cropping-region determination unit 240 determines the size information of the cropping region based on size information of the plurality of local regions. For example, the cropping-region determination unit 240 may determine the cropping region based on a result obtained by executing averaging processing on the size information of the plurality of local regions.

The example hardware configuration in the present embodiment is the same as that in FIG. 1 in the first embodiment, and the configuration diagram is also the same as that in FIG. 2.

As an example in the present embodiment, FIGS. 3A to 3E illustrate time-series images in a case in which a cat is being tracked. An image 301 in FIG. 3A is an image in which the cat is walking toward the left in the initial frame at time t=0. Furthermore, in the second embodiment, reference will be made to the flowcharts in FIGS. 4 and 5B. FIG. 6B illustrates pre-registered information in the present embodiment.

When the image 301 is processed at time t=0, processing is executed in the order of steps S401, S402, and S403, similarly to the first embodiment. In step S403, the tracking-target setting unit 230 sets the whole body of the cat as a tracking-target region 302 as illustrated in FIG. 3A.

Next, in step S401, the image input unit 220 acquires an image 311 in FIG. 3B. Here, the image 311 is an image of the cat at time t=1. In the image 311, the cat that was walking toward the left has stopped. Because the image input unit 220 determines that the image 311 is a frame subsequent to the initial frame in step S402, the cropping-region determination unit 240 executes the cropping-region determination processing in step S404.

FIG. 5B illustrates a detailed flow of the cropping-region determination processing in step S404 executed by the cropping-region determination unit 240 in the second embodiment. Note that description will be simplified for processing in FIG. 5B that is similar to that in FIG. 5A. FIG. 6B illustrates pre-registered information 602 in the second embodiment.

In step S511, the cropping-region determination unit 240 determines whether or not there is a local region that has been detected in the previous frame and that can be used to calculate a cropping region. At time t=1, because the local-region specification processing to be executed in later-described step S408 has not been executed yet, the result of the determination in step S511 is NO, and the cropping-region determination unit 240 moves on to the processing in step S514. In step S514, the cropping-region determination unit 240 sets, as a cropping reference, the pixel count of the whole body of the tracking target set by the tracking-target setting unit 230.

In step S515, from the pre-registered information 602 in FIG. 6B, the cropping-region determination unit 240 acquires, as a cropping magnification ratio, 3.0× corresponding to the whole body, which is the cropping reference.

In step S516, the cropping-region determination unit 240 calculates the pixel count of the cropping region by calculating a product of the pixel count of the whole body of the tracking target set as the cropping reference and the cropping magnification ratio determined in step S515.

The cropping-region determination unit 240 determines the aspect ratio of the cropping region in step S517 and determines the position of the cropping region in step S518. Thus, the cropping-region determination unit 240 determines a cropping region 312 illustrated in FIG. 3B.

In step S405, the cropping unit 250 generates a cropped image 313 in FIG. 3C by executing cropping processing using the cropping region 312 determined in step S404 and processing of resizing the image to QVGA. In step S406, the multitasking unit 260 executes multitask processing to obtain a whole-body detection result 314, a head detection result 315, and a face detection result 316.

In step S407, the tracking-target specification unit 270 specifies a tracking target from among the detection results from the multitasking unit 260. At time t=1, the tracking-target specification unit 270 specifies the whole-body detection result 314 as the tracking target.

In step S408, the local-region specification unit 280 specifies one or more local regions of the tracking target from among the detection results from the multitasking unit 260. At time t=1, the local-region specification unit 280 specifies the head detection result 315 and the face detection result 316 as local regions. Here, the whole-body detection result 314 has been specified as the tracking target, and thus is not adopted as a local region for determining a cropping region.

In step S409, it is determined whether or not all frames have been processed. Because not all frames have been processed at time t=1, processing returns to step S401 and the processing at time t=2 is performed.

In step S401, the image input unit 220 acquires an image 331 in FIG. 3E. The image 331 is an image of the cat at time t=2. In the image 331, the cat that was not moving in the previous frame has started to move again toward the left. Subsequently, the processing from step S402 to step S404 is executed again.

In step S511, the cropping-region determination unit 240 determines whether or not there is a local region that has been detected in the previous frame and that can be used to calculate a cropping region. The head detection result 315 and the face detection result 316 were detected at time t=1. Furthermore, because all of the information registered in the pre-registered information 602 can be set as cropping references in the present embodiment, the cropping-region determination unit 240 moves on to the processing in step S512.

In step S512, the cropping-region determination unit 240 acquires, from the pre-registered information 602, the cropping magnification ratios and weight coefficients of all local regions specified from a plurality of detection targets. In step S513, the cropping-region determination unit 240 calculates the pixel count of a cropping region from the weight coefficient, the cropping magnification ratio, and the pixel count of each cropping reference.

Here, the weight coefficients indicate the degrees of importance of the individual recognition tasks, and more stable pixel counts of cropping regions can be calculated by using the weight coefficients. In the present embodiment, in consideration of the “rate of fluctuation in size in response to change in posture”, the pre-registered information 602 is set so that the weight coefficient is greater for a detection result of which the rate of fluctuation in size is smaller.

A calculation method of a pixel count C of a cropping region in the present embodiment is shown below.

$$\begin{matrix}[ Math . 1 ] & \\ C = \frac{{\sum }_{i = 1}^{N} {W}_{i} {P}_{i} {R}_{i}}{{\sum }_{i = 1}^{N} {W}_{i}} & ( 1.1 )\end{matrix}$$

In formula (1.1), W represents a weight coefficient, P represents the pixel count of a local region, and R indicates a cropping magnification ratio. N represents the number of local regions that have been specified, and, in the present embodiment, the total number of local regions specified is two (the head detection result 315 and the face detection result 316). Furthermore, in the present embodiment, description is provided regarding that the pixel count of the head detection result 315 is 60 pixels, and the pixel count of the face detection result 316 is 20 pixels.

According to the above-described formula (1.1), a pixel count of the cropping region is calculated for each recognition task, and a weighted average of the pixel counts is calculated. The pixel count of the cropping region when the head detection result 315 is adopted as the cropping reference is 900 pixels, which is the product of the pixel count (60 pixels) of the head detection result and the cropping magnification ratio (15.0×) for the head. The pixel count of the cropping region when the face detection result 316 is adopted as the cropping reference is 600 pixels, which is the product of the pixel count (20 pixels) of the face detection result and the cropping magnification ratio (30.0×) for the head. By respectively multiplying the pixel counts by the weight coefficient 5.0 for the head and the weight coefficient 3.0 for the face and calculating the weighted average thereof, the pixel count C of the cropping region is calculated as 787.5 pixels. It can be seen that, by the cropping-region determination unit 240 calculating a pixel count of a cropping region using a plurality of detection results, pixel counts of cropping regions become stable even if the size of the head detection result 315 has been incorrectly detected.

The cropping-region determination unit 240 determines the aspect ratio of the cropping region in step S517 and determines the position of the cropping region in step S518. Thus, the cropping-region determination unit 240 determines a cropping region 332 illustrated in FIG. 3E.

Subsequently, in step S405, the cropping unit 250 generates a cropped image using the cropping region 332. Subsequently, the processing from step S406 to step S409 is executed, and the processing in the present embodiment is concluded.

As described above, in the present embodiment, by calculating size information of a cropping region based on size information of a plurality of detection targets detected by a plurality of recognition tasks, stable cropping regions can be calculated even if the size of some detection results is incorrect.

For example, in the present embodiment, size information of a cropping region is calculated based on a result obtained by executing averaging processing on size information of a plurality of local regions. Thus, cropping regions can be stabilized even if the size information of the plurality of local regions includes an outlier. Note that, while description has been provided in the present embodiment taking a weighted average as an example, this is not necessarily the case; a cropping region may be determined using averaging processing such as a simple average or moving average.

Furthermore, the cropping-region determination unit 240 may determine at least one of the maximum and the minimum of size information of a cropping region using detection results of a plurality of recognition tasks. For example, if priority ranks are set in the pre-registered information, the cropping-region determination unit 240 may calculate a cropping region based on a detection result of a recognition task having the highest priority rank, and set values obtained by multiplying the pixel count of the cropping region by 2.0 and 0.5 as the maximum and the minimum, respectively. Subsequently, if the pixel count of a cropping region exceeds the maximum or falls below the minimum when the cropping-region determination unit 240 calculates a cropping region using a weighted average as in the present embodiment, the cropping-region determination unit 240 sets the pixel count of the cropping region so as to be within the range of the maximum and the minimum that have been set. By setting the maximum and the minimum as described above, a cropping region can be set within the range of 0.5 to 2.0 times the pixel count of the cropping region calculated from the recognition task having the highest priority rank.

According to the above, the performance of the multitasking means can be stabilized using detection results of a plurality of recognition tasks.

### Third Embodiment: Use of Time-Series Information to Determine Cropping Reference to be Used to Calculate Cropping Region

In the present embodiment, a method for determining a cropping reference using time-series information will be described, taking as an example a case in which a cat is walking. For example, in the present embodiment, the local-region specification unit 280 specifies a plurality of local regions from a plurality of images corresponding to different times. The cropping-region determination unit 240 determines size information of a cropping region based on size information of at least one of the plurality of local regions. Here, the local-region specification unit 280 may specify a plurality of local regions of a plurality of types of detection targets, e.g., the head and the face. In other words, the local-region specification unit 280 may specify, from each of a plurality of images corresponding to different times, local regions of a plurality of mutually different types of detection targets. The cropping-region determination unit 240 may determine the size information of the cropping region based on size information of a local region of a detection target selected from among the plurality of types of detection targets. For example, the cropping-region determination unit 240 may determine the size information of the cropping region based on the size information of the local region of the detection target selected based on a change in size information of the local regions. For example, the change in size information of a local region may be the rate of change in size of the local region that is specified from the images corresponding to different times. Here, the size may be any of the pixel count of the local region, the product of the vertical and horizontal lengths of the local region, and the like.

The example hardware configuration in the present embodiment is the same as that in FIG. 1 in the first embodiment, and the configuration diagram is also the same as that in FIG. 2.

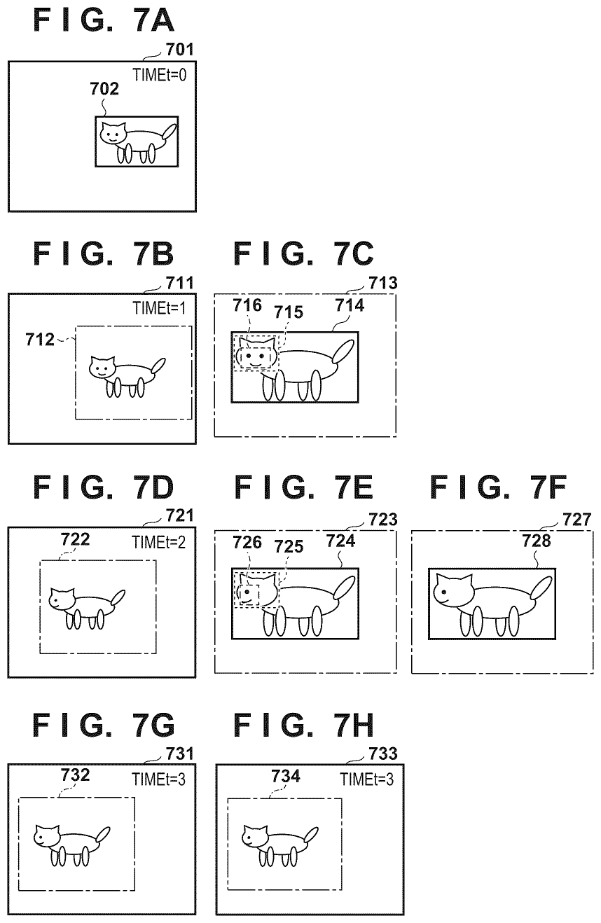

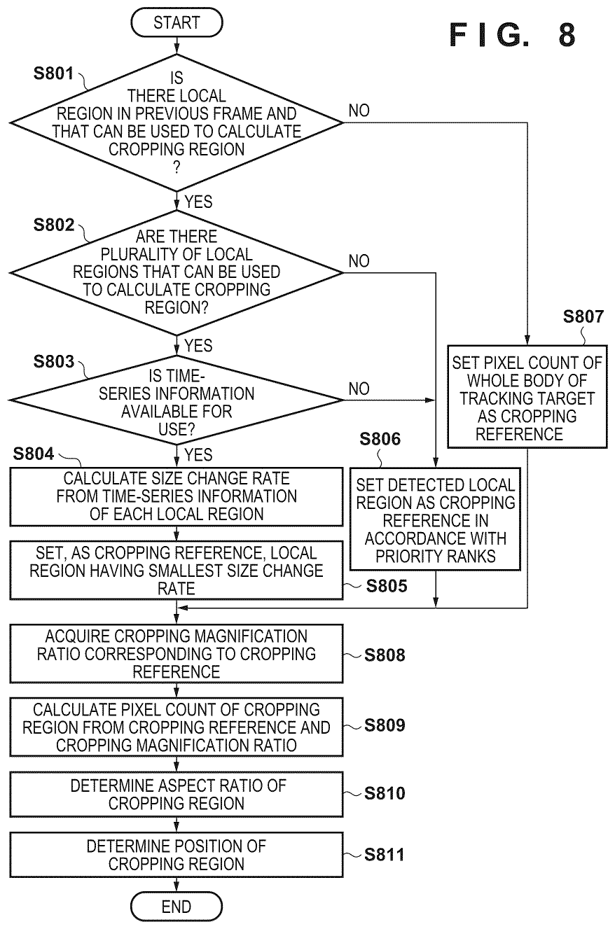

As an example in the present embodiment, FIGS. 7A to 7H illustrate time-series images in a case in which a cat is being tracked. An image 701 in FIG. 7A is an image in which the cat is walking toward the left in the initial frame at time t=0. Furthermore, in the third embodiment, reference will be made to the flowcharts in FIGS. 4 and 8. FIG. 6C illustrates pre-registered information in the present embodiment.

When the image 701 is processed at time t=0, processing is executed in the order of steps S401, S402, and S403, similarly to the first embodiment. In step S403, the tracking-target setting unit 230 sets the whole body of the cat as a tracking-target region 702 as illustrated in FIG. 7A.

Next, in step S401, the image input unit 220 acquires an image 711 in FIG. 7B. Here, the image 711 is an image of the cat at time t=1. In the image 711, the cat is still moving toward the left. Because the image input unit 220 determines that the image 711 is a frame subsequent to the initial frame in step S402, the image input unit 220 moves on to cropping-region determination processing in step S404.

FIG. 8 illustrates a detailed flow of the cropping-region determination processing in step S404 executed by the cropping-region determination unit 240 in the third embodiment. Note that description will be simplified for processing in FIG. 8 that is similar to that in the above-described embodiments.

In step S801, the cropping-region determination unit 240 determines whether or not there is a local region that has been detected in the previous frame and that can be used to calculate a cropping region. At time t=1, there is no local region because the local-region specification processing to be executed in later-described step S408 has not been executed yet. Accordingly, the cropping-region determination unit 240 makes a determination of “NO” in step S801 and moves on to the processing in step S807.

In step S807, the cropping-region determination unit 240 sets, as a cropping reference, the pixel count of the whole body of the tracking target set by the tracking-target setting unit 230.

In step S808, from the pre-registered information 603 in FIG. 6C, the cropping-region determination unit 240 acquires, as a cropping magnification ratio, 3.0× corresponding to the whole body, which is the cropping reference.

In step S809, the cropping-region determination unit 240 calculates the pixel count of the cropping region by calculating a product of the pixel count of the whole body of the tracking target set as the cropping reference and the cropping magnification ratio determined in step S808.

The cropping-region determination unit 240 determines the aspect ratio of the cropping region in step S810 and determines the position of the cropping region in step S811. Thus, the cropping-region determination unit 240 determines a cropping region 712 illustrated in FIG. 7B.

In step S405, the cropping unit 250 generates a cropped image 713 in FIG. 7C by executing cropping processing using the cropping region 712 determined in step S404 and processing of resizing the image to QVGA.

In step S406, the multitasking unit 260 executes multitask processing to obtain a whole-body detection result 714, a head detection result 715, and a face detection result 716.

In step S407, the tracking-target specification unit 270 specifies a tracking target from among the detection results from the multitasking unit 260. At time t=1, the tracking-target specification unit 270 specifies the whole-body detection result 714 as the tracking target.

In step S408, the local-region specification unit 280 specifies one or more local regions of the tracking target from among the detection results from the multitasking unit 260. At time t=1, the local-region specification unit 280 specifies the head detection result 715 and the face detection result 716 as local regions.

In step S409, it is determined whether or not all frames have been processed. Because not all frames have been processed at time t=1, processing returns to step S401 and the processing at time t=2 is performed.

In step S401, the image input unit 220 acquires an image 721 in FIG. 7D. Here, the image 721 is an image of the cat at time t=2. In the image 721, the cat is still moving toward the left. Subsequently, the processing from step S402 to step S404 is executed again.

In step S801, the cropping-region determination unit 240 determines whether or not there is a local region that has been detected in the previous frame and that can be used to calculate a cropping region. The head detection result 715 and the face detection result 716 were detected in the previous frame at time t=1. Furthermore, because all of the information registered in the pre-registered information 603 can be used to calculate a cropping region in the present embodiment, the cropping-region determination unit 240 determines that there is a local region in the previous frame and moves on to the processing in step S802.

In step S802, the cropping-region determination unit 240 determines whether there are a plurality of local regions that can be used to calculate a cropping region. Because the head detection result 715 and the face detection result 716 were detected at time t=1, the cropping-region determination unit 240 determines that there are a plurality of local regions that can be used and moves on to the processing in step S803.

In step S803, the cropping-region determination unit 240 determines whether time-series information of the local-region detection results is available for use. At time t=2, only the detection results at time t=1 are present, and thus there is not enough information about the local regions, detection results, or the like specified from a plurality of images corresponding to different times to determine temporal changes in the local regions. Thus, the cropping-region determination unit 240 determines that time-series information is not available for use, and moves on to the processing in step S806.

In step S806, the cropping-region determination unit 240 sets a detected local region as a cropping reference in accordance with priority ranks. Because it can be ascertained from the pre-registered information 603 that the priority rank of the face detection result is highest, the cropping-region determination unit 240 sets the pixel count of the face region as the cropping reference.

In step S808, from the pre-registered information 603 in FIG. 6C, the cropping-region determination unit 240 acquires and sets, as a cropping magnification ratio, 30.0× associated with the face.

In step S809, the cropping-region determination unit 240 calculates the pixel count of the cropping region by calculating a product of the pixel count of the face set as the cropping reference and the cropping magnification ratio determined in step S808. The cropping-region determination unit 240 determines the aspect ratio of the cropping region in step S810 and determines the position of the cropping region in step S811. Thus, the cropping-region determination unit 240 determines a cropping region 722 illustrated in FIG. 7D.

In step S405, the cropping unit 250 generates a cropped image 723 in FIG. 7E by executing cropping processing using the cropping region 722 determined in step S404 and processing of resizing the image to QVGA.

In step S406, the multitasking unit 260 executes multitask processing to obtain a whole-body detection result 724, a head detection result 725, and a face detection result 726.

In step S407, the tracking-target specification unit 270 specifies a tracking target from among the detection results from the multitasking unit 260. At time t=2, the tracking-target specification unit 270 specifies the whole-body detection result 724 as the tracking target.

In step S408, the local-region specification unit 280 specifies one or more local regions of the tracking target from among the detection results from the multitasking unit 260. At time t=2, the local-region specification unit 280 specifies the head detection result 725 and the face detection result 726 as local regions.

In step S409, it is determined whether or not all frames have been processed. Because not all frames have been processed at time t=2, processing returns to step S401 and the processing at time t=3 is performed.

In step S401, the image input unit 220 acquires an image 731 in FIG. 7G. The image 731 is an image of the cat at time t=3. In the image 731, the cat is still moving toward the left. Subsequently, the processing from step S402 to step S404 is executed again.

In step S801, the cropping-region determination unit 240 determines whether or not there is a local region that has been detected in the previous frame and that can be used to calculate a cropping region. The head detection result 725 and the face detection result 726 were detected in the previous frame at time t=2. Accordingly, the cropping-region determination unit 240 determines that there is a local region, and moves on to the processing in step S802.

In step S802, the cropping-region determination unit 240 determines whether there are a plurality of local regions that can be used for cropping. The head detection result 725 and the face detection result 726 were detected at time t=2. Accordingly, the cropping-region determination unit 240 determines that there are a plurality of local regions, and moves on to the processing in step S803.

In step S803, the cropping-region determination unit 240 determines whether time-series information of the local-region detection results is available for use. At time t=3, the detection results at time t=1 and time t=2 are present, and thus there is enough information to determine temporal changes in the local regions. Thus, the cropping-region determination unit 240 determines that time-series information is available for use, and moves on to the processing in step S804. In the present embodiment, it is determined that time-series information is available for use if local-region detection results for past two frames are present; however, there is no limitation to this.

In step S804, the cropping-region determination unit 240 calculates a size change rate from time-series information of each local region.

The size change rate is a value obtained by calculating how much the size (pixel count) has changed from size information of a local-region detection result in a past frame. In the present embodiment, the cropping-region determination unit 240 calculates how much the size has changed from the originally detected local-region size by comparing size information of the detection result from two frames ago and size information of the detection result in the previous frame; however, this is not necessarily the case. For example, the cropping-region determination unit 240 may calculate the size change rate by calculating the variance, standard deviation, etc., of sizes in time-series information of a local region. It can be seen that the size change rate of the whole body is small because the orientation of the cat's body has not changed between the whole-body detection result 714 and the whole-body detection result 724. It can be seen that the size change rate of the face is great because the orientation of the cat's face has changed from forward to sideways between the face detection result 716 and the face detection result 726. It can be seen that, between the head detection result 715 and the head detection result 725, the amount of change in the detection result of head size is small even if the cat faces sideways.

In step S805, the cropping-region determination unit 240 sets, as a cropping reference, the pixel count of the local region having the smallest size change rate. In the present embodiment, the cropping-region determination unit 240 determines that the region having the smallest size change rate is the head, and sets the pixel count of the head as a cropping reference. Here, if the method according to the first embodiment were adopted, the pixel count of the face would be set as a cropping reference according to the priority ranks, and thus the cropping region would become smaller than that at time t=2.

In step S808, from the pre-registered information 603 in FIG. 6C, the cropping-region determination unit 240 acquires, as a cropping magnification ratio, 15.0× associated with the head.

In step S809, the cropping-region determination unit 240 calculates the pixel count of the cropping region by calculating a product of the pixel count of the head set as the cropping reference and the cropping magnification ratio determined in step S808.

The cropping-region determination unit 240 determines the aspect ratio of the cropping region in step S810 and determines the position of the cropping region in step S811. Thus, the cropping-region determination unit 240 determines a cropping region 732 illustrated in FIG. 7G.

Subsequently, in step S405, the cropping unit 250 generates a cropped image using the cropping region 732. Subsequently, the processing from step S406 to step S409 is executed, and the processing in the present embodiment is concluded.

As described above, the information processing apparatus in the third embodiment can set stable cropping regions by calculating a cropping region using one among a plurality of local regions that is specified by using a plurality of images corresponding to different times as time-series information. For example, in the present embodiment, the local region to be used to calculate the cropping region is selected based on rates of change of size information of the local regions. Specifically, in the present embodiment, the cropping region is determined using the local region for which the change in size information is small. Thus, in the present embodiment, stable cropping regions can be calculated appropriately even if the priority rank is high for a local region that is not suitable for a stable cropping region or even if priority ranks are not set.

Furthermore, in the present embodiment, description is provided of a method for determining a cropping reference from among local regions of different types, such as the face and the head. For example, even in a case in which there are a plurality of candidate local regions of the same type, such as the pupils and legs (e.g., two candidate local regions in the case of the pupils), one local region that is suitable for calculating a cropping region may be determined according to the above-described method.

### Fourth Embodiment: Use of Time-Series Information to Determine Cropping Region in Case in which Recognition Task(s) Result in No Detection

In the present embodiment, a method for determining a cropping region in a case in which a recognition task having a high priority rank results in no detection will be described, taking as an example a case in which a cat is walking. Specifically, in the present embodiment, the local-region specification unit 280 specifies a plurality of local regions from a plurality of frame images corresponding to different times. Based on a change between the plurality of local regions corresponding to different times, the cropping-region determination unit 240 sets a cropping region in the current image based on a cropping region in the previous frame image (i.e., the image corresponding to the previous time). Furthermore, if there are no local regions corresponding to the previous time, the cropping-region determination unit 240 determines whether or not to set the current cropping region based on the previous cropping region.

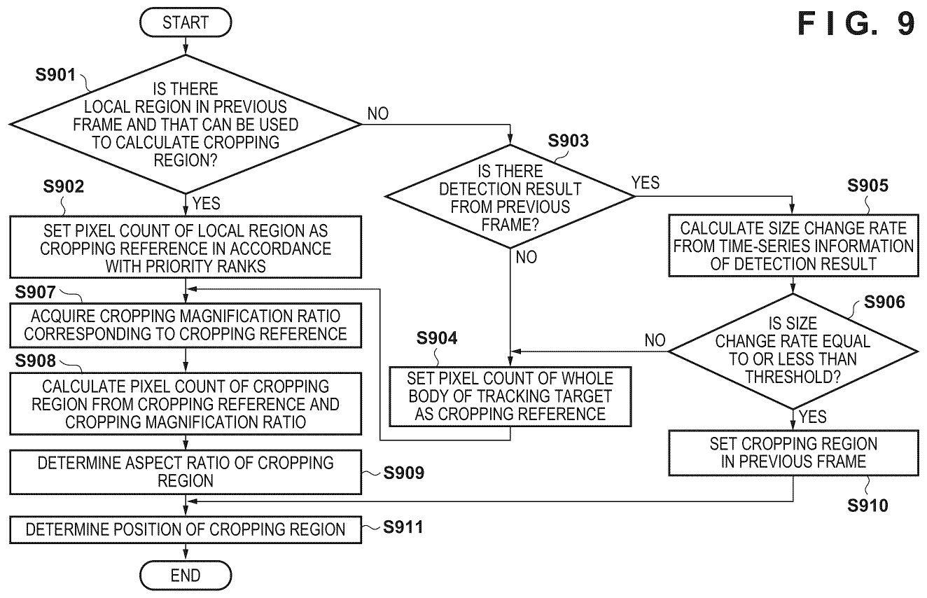

As an example in the fourth embodiment, FIGS. 7A to 7H illustrate time-series images in a case in which a cat is being tracked. An image 701 in FIG. 7A is an image in which the cat is walking toward the left in an initial frame corresponding to time t=0. Furthermore, in the fourth embodiment, reference will be made to the flowcharts in FIG. 4 and FIG. 9. FIG. 6D illustrates pre-registered information in the fourth embodiment.

When the image 701 is processed at time t=0, processing is executed in the order of steps S401, S402, and S403, similarly to the third embodiment. In step S403, the tracking-target setting unit 230 sets the whole body of the cat as a tracking-target region 702 as illustrated in FIG. 7A.

Next, in step S401, an image 711 in FIG. 7B is acquired. Here, the image 711 is an image of the cat at time t=1. In the image 711, the cat is still moving toward the left. Because the image input unit 220 determines that the image 711 is a frame subsequent to the initial frame in step S402, the image input unit 220 moves on to cropping-region determination processing in step S404.

FIG. 9 illustrates a detailed flow of the cropping-region determination processing in step S404 executed by the cropping-region determination unit 240 in the fourth embodiment.

In step S901, the cropping-region determination unit 240 determines whether or not there is a local region that has been detected in the previous frame and that can be used to calculate a cropping region. Because the processing by the multitasking unit 260 has not been executed yet at time t=1, the cropping-region determination unit 240 determines that there is no detected local region, and moves on to the processing in step S903.

In step S903, the cropping-region determination unit 240 determines whether there is a detection result from the previous frame. Because the processing by the multitasking unit 260 has not been executed yet at time t=1, the cropping-region determination unit 240 determines that there is no detection result from the previous frame, and moves on to the processing in step S904.

In step S904, the cropping-region determination unit 240 sets, as a cropping reference, the pixel count of the whole body of the tracking target set by the tracking-target setting unit 230.

In step S907, from the pre-registered information 604 in FIG. 6D, the cropping-region determination unit 240 acquires, as a cropping magnification ratio, 3.0× corresponding to the whole body, which is the cropping reference.

In step S908, the cropping-region determination unit 240 calculates the pixel count of the cropping region by calculating a product of the pixel count of the whole body of the tracking target set as the cropping reference and the cropping magnification ratio determined in step S907.

The cropping-region determination unit 240 determines the aspect ratio of the cropping region in step S909 and determines the position of the cropping region in step S911. Thus, the cropping-region determination unit 240 determines a cropping region 712 illustrated in FIG. 7B.

In step S405, the cropping unit 250 generates a cropped image 713 in FIG. 7C by executing cropping processing using the cropping region 712 determined in step S404 and processing of resizing the image to QVGA.

In step S406, the multitasking unit 260 executes multitask processing to obtain a whole-body detection result 714, a head detection result 715, and a face detection result 716.

In step S407, the tracking-target specification unit 270 specifies a tracking target from among the detection results from the multitasking unit 260. At time t=1, the tracking-target specification unit 270 specifies the whole-body detection result 714 as the tracking target.

In step S408, the local-region specification unit 280 specifies one or more local regions of the tracking target from among the detection results from the multitasking unit 260. At time t=1, the local-region specification unit 280 specifies the head detection result 715 and the face detection result 716 as local regions.

In step S409, it is determined whether or not all frames have been processed. Because not all frames have been processed at time t=1, processing returns to step S401 and the processing at time t=2 is performed.

In step S401, the image input unit 220 acquires an image 721 in FIG. 7D. Here, the image 721 is an image of the cat at time t=2. In the image 721, the cat is still moving toward the left. Subsequently, the processing from step S402 to step S404 is executed again.

In step S901, the cropping-region determination unit 240 determines whether or not there is a local region that has been detected in the previous frame and that can be used to calculate a cropping region. The head detection result 715 and the face detection result 716 were detected in the previous frame at time t=1. Furthermore, because all of the information registered in the pre-registered information 604 can be set as cropping references in the present embodiment, the cropping-region determination unit 240 moves on to the processing in step S902.

In step S902, the cropping-region determination unit 240 sets a detected local region as a cropping reference in accordance with priority ranks. Because it can be ascertained from the pre-registered information 604 that the priority rank of the head is highest, the cropping-region determination unit 240 sets the pixel count of the head as the cropping reference.

In step S907, from the pre-registered information 604 in FIG. 6D, the cropping-region determination unit 240 acquires, as a cropping magnification ratio, 15.0× corresponding to the head, which is the cropping reference.

In step S908, the cropping-region determination unit 240 calculates the pixel count of the cropping region by calculating a product of the pixel count of the head set as the cropping reference and the cropping magnification ratio determined in step S907.

The cropping-region determination unit 240 determines the aspect ratio of the cropping region in step S909 and determines the position of the cropping region in step S911. Thus, the cropping-region determination unit 240 determines a cropping region 722 illustrated in FIG. 7D.

In step S405, the cropping unit 250 generates a cropped image 727 in FIG. 7F by executing cropping processing using the cropping region 722 determined in step S404 and processing of resizing the image to QVGA.

In step S406, the multitasking unit 260 executes multitask processing to obtain only a whole-body detection result 728, whereas the head and the face are undetected.

In step S407, the tracking-target specification unit 270 specifies a tracking target from among the detection results from the multitasking unit 260. At time t=2, the tracking-target specification unit 270 specifies the whole-body detection result 728 as the tracking target.

In step S408, the local-region specification unit 280 specifies one or more local regions of the tracking target from among the detection results from the multitasking unit 260. At time t=2, the local-region specification unit 280 does not detect any local regions.

In step S409, it is determined whether or not all frames have been processed. Because not all frames have been processed at time t=2, processing returns to step S401 and the processing at time t=3 is performed.

In step S401, the image input unit 220 acquires an image 733 in FIG. 7H. The image 733 is an image of the cat at time t=3. In the image 733, the cat is still moving toward the left. Subsequently, the processing from step S402 to step S404 is executed again.

In step S901, the cropping-region determination unit 240 determines whether or not there is a local region that has been detected in the previous frame and that can be used to calculate a cropping region. Because the head and the face were undetected at time t=2, the cropping-region determination unit 240 determines that there is no detected local region, and moves on to the processing in step S903.

In step S903, the cropping-region determination unit 240 determines whether there is a detection result from the previous frame. Because the whole-body detection result 728 was detected at time t=2, the cropping-region determination unit 240 determines that there is a detection result from the previous frame and moves on to the processing in step S905.

In step S905, the cropping-region determination unit 240 calculates a size change rate from time-series information of the detection result. Similarly to that described in the third embodiment, the size change rate is a value obtained by calculating how much the size has changed from size information (pixel count) of a detection result in a past frame. For example, the cropping-region determination unit 240 may calculate, as the size change rate, the change between the size of a local region at a given time and the size of the local region immediately after the given time.

In step S906, the cropping-region determination unit 240 determines whether the size change rate is equal to or less than a threshold. If the size change rate between the whole-body detection result 714 and the whole-body detection result 728 is low, and the cropping-region determination unit 240 thus determines that the size change rate is equal to or less than the threshold, the cropping-region determination unit 240 moves on to the processing in step S910. On the other hand, the cropping-region determination unit 240 moves on to the processing in step S904 upon determining that the size change rate is greater than the threshold.

In step S910, the cropping-region determination unit 240 sets the cropping region in the previous frame as the cropping region in the current frame. In other words, if local regions at the previous time are undetected and the size change rate is equal to or less than the threshold, the cropping-region determination unit 240 determines the cropping region at the previous time as the current cropping region.

Here, in the third embodiment for example, the whole body of the tracking target, of which the “rate of fluctuation in size in response to change in posture” is great, may be set as a cropping reference because local regions in the previous frame that can be used to calculate a cropping region are undetected in the current frame. In the present embodiment, the cropping-region determination unit 240 determines that there is no significant change in the posture of the tracking target based on the local-region size change rate, in the current frame, of a region of which the “size change rate in response to change in posture” is large. The cropping-region determination unit 240 can use the cropping region for the previous frame as the cropping region for the current frame upon determining that the size change rate is small, and there is no significant change in the captured state of the tracking target.

Subsequently, in step S911, the cropping-region determination unit 240 determines the position of the cropping region. Thus, the cropping-region determination unit 240 determines a cropping region 734 illustrated in FIG. 7H.

Subsequently, in step S405, the cropping unit 250 generates a cropped image using the cropping region 734. Subsequently, the processing from step S406 to step S409 is executed, and the processing in the present embodiment is concluded.

As described above, the information processing apparatus in the fourth embodiment can perform the cropping processing using a cropping region for the previous frame as a cropping region for the current frame by checking that there is no significant change in the captured state of the tracking target based on the size change rate of a region of which the “size change rate in response to change in posture” is great. However, in regard to the position of the cropping region, there is no need to use the coordinates in the previous frame, and cropping-region position may be changed in accordance with subject motion. Furthermore, while the size change rate is used to check that there is no significant change in the captured state of the tracking target in the present embodiment, the check may be performed using the recognition accuracy of the tracking target. Here, the recognition accuracy is a recognition rate calculated from the number of frames in which the tracking target has been recognized, a recognition score indicating the likelihood of the recognition target, or the like.

Furthermore, while it is determined in the present embodiment whether the cropping processing can be performed using the cropping region in the previous frame, it may be determined whether size information of a local region in the previous frame can be used for the current frame. By performing the above-described determination, a cropping region can be calculated using a local region in the previous frame even if the local region used to calculate the cropping region in the previous frame is undetected in the current frame.

Due to the above, stable cropping regions can be calculated even if a recognition task having a high priority rank results in no detection.

### Fifth Embodiment: Multitasking Executed on Images of Different Sizes

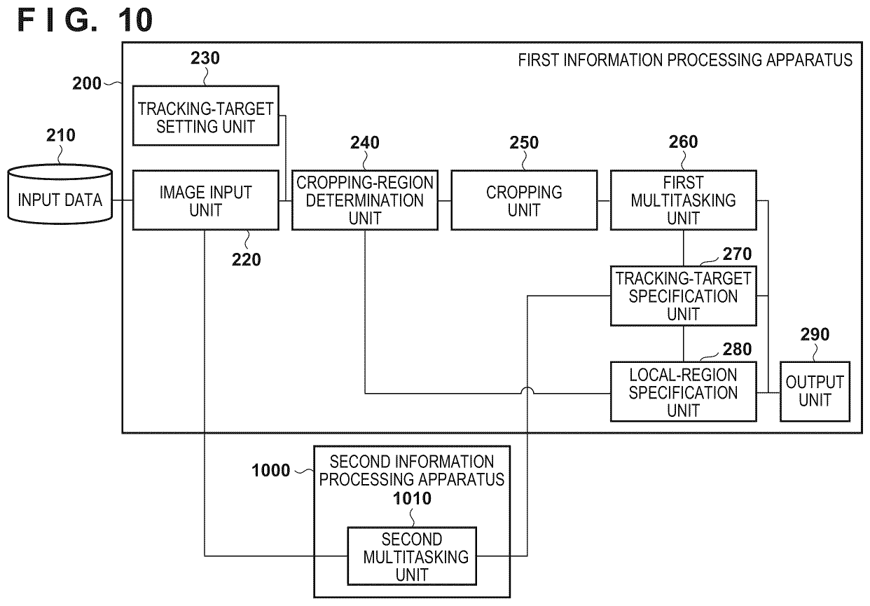

FIG. 10 is a diagram describing a first information processing apparatus 200 and a second information processing apparatus 1000 according to the fifth embodiment. The image input unit 220, tracking-target setting unit 230, cropping-region determination unit 240, cropping unit 250, first multitasking unit 260, tracking-target specification unit 270, local-region specification unit 280, and output unit 290 in FIG. 10 perform operations similar to those of the corresponding components in the first embodiment, and description thereof is thus omitted.

The second information processing apparatus 1000 receives input data 210 from the image input unit 220. A second multitasking unit 1010 executes a plurality of recognition tasks on image data in the input data 210. In the present embodiment, the second multitasking unit 1010 executes processing on an uncropped image; however, there is no limitation to this, and the second multitasking unit 1010 may execute the recognition tasks on any image larger than a cropped image. For example, the second multitasking unit 1010 may execute the recognition tasks on a cropped image having half the image size, a cropped image having a 1:1 image aspect ratio, or the like. Accordingly, the local-region specification unit 280 specifies one or more local regions from a cropped image and an image that is larger than the cropped image. Note that the second multitasking unit 1010 may be provided to the first information processing apparatus 200. In this case, the first information processing apparatus 200 and the second information processing apparatus 1000 would be integrated into one information processing apparatus.

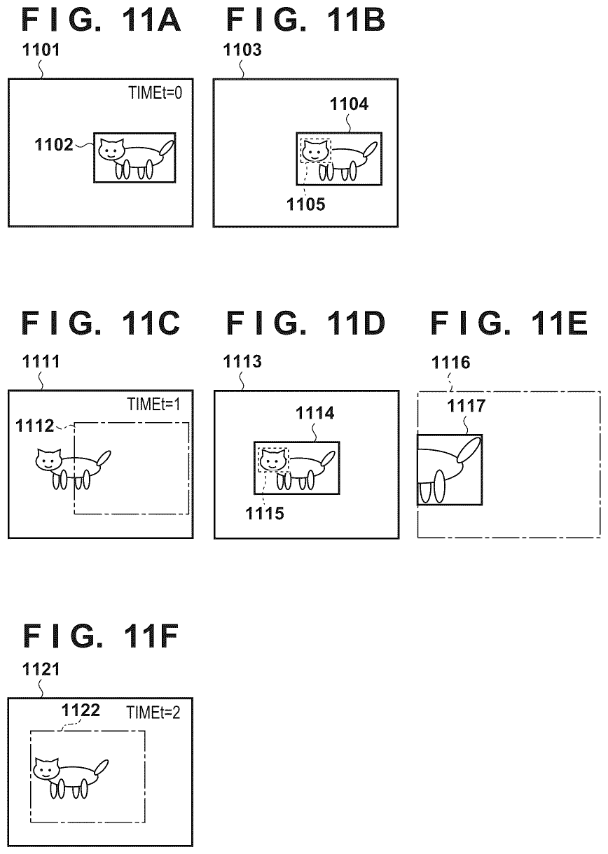

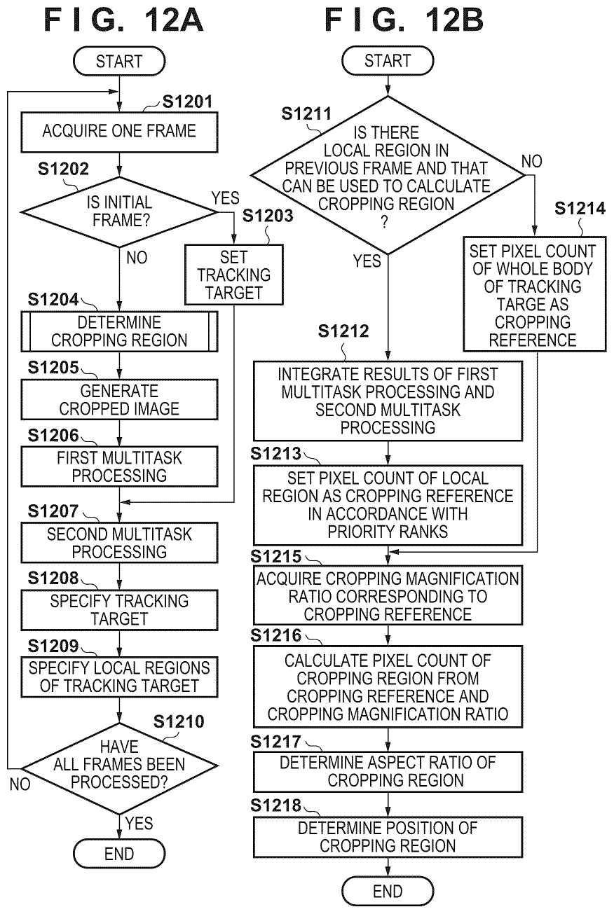

As an example in the fifth embodiment, FIGS. 11A to 11F illustrate time-series images in a case in which a cat is being tracked. Furthermore, FIG. 12 illustrates a flowchart of processing in the present embodiment. FIG. 12A illustrates the entire flowchart. FIG. 12B illustrates a detailed flow of the cropping-region determination processing in step S1204. FIG. 6A illustrates pre-registered information in the present embodiment.

In step S1201, the image input unit 220 acquires an image of one frame that is input as input data 210. Here, the image input unit 220 acquires an image 1101 in FIG. 11A. The image 1101 in FIG. 11A is an image of the initial frame at time t=0. In the image 1101, a cat is walking toward the left.

In step S1202, the image input unit 220 determines whether or not the acquired frame is the initial frame in the acquired input data 210. Upon acquiring an image of the initial frame at time t=0, the image input unit 220 determines that the frame is the initial frame, and moves on to step S1203.

In step S1203, the tracking-target setting unit 230 sets a tracking target. Here, in step S1203, the tracking-target setting unit 230 sets the cat as the tracking target, and sets the position and size of the tracking target. In the present embodiment, the tracking-target setting unit 230 sets the whole body of the cat as a tracking-target region 1102 as illustrated in FIG. 11A.

In step S1207, after the tracking target has been set, the second multitasking unit 1010 executes second multitask processing. FIG. 11B illustrates the result of the second multitask processing. An image 1103 in FIG. 11B illustrates an image on which the second multitask processing has been executed, and the same image as image 1101 is used in the present embodiment. The second multitasking unit 1010 detects a whole-body detection result 1104 and a head detection result 1105 based on the image 1103.

In step S1208, the tracking-target specification unit 270 specifies a tracking target from among the detection results from the second multitasking unit 1010. At time t=0, the tracking-target specification unit 270 specifies the whole-body detection result 1104 as the tracking target.

In step S1209, the local-region specification unit 280 specifies one or more local regions of the tracking target from among the detection results from the second multitasking unit 1010. At time t=0, the local-region specification unit 280 specifies the head detection result 1105 as a local region.

In step S1210, it is determined whether or not all frames have been processed. Because not all frames have been processed at time t=0, processing returns to step S1201 and the processing at time t=1 is performed.

In step S1201, the image input unit 220 acquires an image 1111 illustrated in FIG. 11C. Here, the image 1111 is an image of the cat at time t=1. In the image 1111, the cat is still moving toward the left.

Because the image input unit 220 determines that the image 1111 is a frame subsequent to the initial frame in step S1202, the image input unit 220 moves on to the cropping-region determination processing in step S1204.

FIG. 12B illustrates a detailed flow of the cropping-region determination processing in step S1204.

In step S1211, the cropping-region determination unit 240 determines whether or not there is a local region that has been detected in the previous frame and that can be used to calculate a cropping region. Because the head detection result 1105 obtained from the second multitasking unit 1010 is present at time t=1, the cropping-region determination unit 240 determines that there is a local region detected in the previous frame, and moves on to the processing in step S1212. On the other hand, if a local region in the previous frame that can be used to calculate a cropping region, such as the head detection result 1105, is not present, the cropping-region determination unit 240 determines that there is no local region, and moves on to step S1214 to set the pixel count of the whole body of the tracking target that has been set by the tracking-target setting unit 230 as the cropping reference. Subsequently, the cropping-region determination unit 240 moves on to later-described step S1215.

In step S1212, the cropping-region determination unit 240 integrates the results of the first multitask processing and the second multitask processing. For example, if the head is detected in both types of multitask processing, the cropping-region determination unit 240 determines a pixel count using the head region as a local region. The cropping-region determination unit 240 in the present embodiment uses the average of the pixel counts of the head regions detected by the two types of processing to determine the pixel count of the head region. Note that the pixel count is not limited to being determined in this way, and may be determined using a weighted average of the two regions or using one of the two regions. Furthermore, if there is only one detection result, the cropping-region determination unit 240 may use the pixel count of the only one head detection result.

In step S1213, the cropping-region determination unit 240 sets the pixel count of the head detection result 1105 as a cropping reference in accordance with priority ranks in the pre-registered information 601 in FIG. 6A.

In step S1215, from the pre-registered information 601 in FIG. 6A, the cropping-region determination unit 240 acquires 15.0× corresponding to the head as a cropping magnification ratio.

In step S1216, the cropping-region determination unit 240 calculates the pixel count of the cropping region by calculating a product of the pixel count of the head set as the cropping reference and the cropping magnification ratio determined in step S1215.

The cropping-region determination unit 240 determines the aspect ratio of the cropping region in step S1217 and determines the position of the cropping region in step S1218. Thus, the cropping-region determination unit 240 determines a cropping region 1112 illustrated in FIG. 11C.

In step S1205, the cropping unit 250 generates a cropped image 1116. For example, the cropping unit 250 crops the image 1111 using the cropping region 1112 determined as a result of step S1204, and resizes the resultant image. As a result of the above-described processing, the cropping unit 250 generates a cropped image 1116 illustrated in FIG. 11E. At time t=1, the cat's head and a part of the cat's whole body exceed the boundaries of the cropping region because the cat has moved abruptly.

In step S1206, the first multitasking unit 260 executes the first multitask processing on the cropped image 1116 in FIG. 11E. As illustrated in FIG. 11E, only a whole-body detection result 1117 is obtained as a result from the first multitasking unit 260 at time t=1 because the cat's body has exceeded the boundaries of the cropping region.

In step S1207, the second multitasking unit 1010 executes the second multitask processing. FIG. 11D illustrates the result of the second multitask processing. An image 1113 in FIG. 11D illustrates an image on which the second multitask processing has been executed, and is a processing result obtained by using the same image as the image 1111. The second multitasking unit 1010 executes the second multitask processing on the image 1111, and detects a whole-body detection result 1114 and a head detection result 1115 as illustrated in the image 1113.

In step S1208, the tracking-target specification unit 270 specifies a tracking target from among the results of detection by the first multitasking unit 260 and the second multitasking unit 1010. At time t=1, the tracking-target specification unit 270 specifies the whole-body detection result 1114 as the tracking target as illustrated in FIG. 11D.

In step S1209, the local-region specification unit 280 specifies one or more local regions of the tracking target from among the detection results from the first multitasking unit 260 and the second multitasking unit 1010. At time t=1, the local-region specification unit 280 specifies the head detection result 1115 as a local region as illustrated in FIG. 11D.

In step S1210, it is determined whether or not all frames have been processed. Because not all frames have been processed at time t=1, processing returns to step S1201 and the processing at time t=2 is performed.

In step S1201, the image input unit 220 acquires an image 1121 in FIG. 11F. The image 1121 is an image of the cat at time t=2. In the image 1121, the cat is still moving toward the left. Subsequently, the processing from step S1202 to step S1204 is executed again.

In step S1211, the cropping-region determination unit 240 determines whether or not there is a local region that has been detected in the previous frame and that can be used to calculate a cropping region. Because the head detection result 1115 was detected at time t=2, the cropping-region determination unit 240 determines that there is a local region and moves on to the processing in step S1212.

In step S1212, the cropping-region determination unit 240 integrates the results of the first multitask processing and the second multitask processing. Here, because there is only one detection result of the head, the cropping-region determination unit 240 integrates the results of processing by directly using the result from the second multitasking unit 1010 for the head. In regard to the whole body, the cropping-region determination unit 240 integrates the results of processing by adopting, as the pixel count of the whole body, the average of the pixel counts of the whole-body detection result 1114 and the whole-body detection result 1117.

In step S1213, the cropping-region determination unit 240 sets the pixel count of the head set in step S1212 as a cropping reference in accordance with priority ranks in the pre-registered information 601.

Subsequently, the cropping-region determination unit 240 determines a cropping region 1122 illustrated in FIG. 11F by executing the processing from step S1215 to step S1218, as was the case at time t=1.

In step S1205, the cropping unit 250 generates a cropped image using the cropping region 1122.

Subsequently, the processing from step S1206 to step S1210 is executed, and the series of processing is concluded.

As described above, in the fifth embodiment, the calculation of cropping regions can be stabilized to a further extent by executing the first multitask processing and the second multitask processing using a cropped image and an image larger than the cropped image. In the present embodiment, even in a case in which a cat's body has exceeded the boundaries of a cropped image, cropping can be executed using a local region of which the “rate of fluctuation in size in response to change in posture” is small by using the detection result of the second multitask processing, which is executed on an image larger than the cropped image. Furthermore, while processing is executed on an uncropped image in the present embodiment, the processing may be executed on any image that is different from the cropped image generated by the cropping unit 250.

### OTHER EMBODIMENTS

While description has been provided in the above-described embodiments based on an example in which a cat is the tracking target, object of other categories, such as a person or a motorcycle, may be adopted as tracking targets. Upon applying the present embodiments to other categories, a local region to be adopted as a cropping reference may be newly set by using the “rate of fluctuation in size in response to change in posture” as an index. For example, in the case of a person, the rate of fluctuation in size would be great for the whole-body region and small for the head region. Furthermore, in the case of a motorbike, the rate of fluctuation in size would be great for the whole-vehicle-body region and small for tire length. Thus, while a cropping reference was determined based on priority ranks and the size change rate in the above-described embodiment, a cropping reference may be determined based on the category classification result of the tracking target. Combinations of a category and a cropping reference may be determined in advance, such as the head as the cropping reference when a person is being tracked, a tire as a cropping reference when a motorcycle is being tracked, etc., for example.

In the above-described embodiments, description has been provided based on an example in which a cropping region is determined based on a local region selected from a plurality of local regions; however, the method for determining a cropping region is not limited to this. For example, a configuration may be adopted such that: priority ranks are set to parts such as the whole body, the head, and the face; a local region is set only to a part having a high priority rank among detected parts; and a cropping region is determined based on the set local region.

While the above-described embodiments have been described on the assumption that multitask processing is executed, multitask processing need not be executed. In this case, it is sufficient that the local-region specification unit 280 specify a local region by detecting a part in accordance with a predetermined part, or the like.

In the above-described embodiments, description has been provided based on an example in which the input data 210 is a moving image; however, there is no limitation to this. For example, the input data 210 may be a plurality of still images captured at predetermined intervals of time from one another, a plurality of images in a time-lapse.

The above-described embodiments may be combined as appropriate.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-022202, filed Feb. 16, 2024, which is hereby incorporated by reference herein in its entirety.

What is claimed is:

1. An information processing apparatus comprising:
one or more memories storing instructions; and
one or more processors executing the instructions to:
execute tracking-target specification processing of specifying, as a tracking target, a target to be tracked that is included in an image;
execute local-region specification processing of specifying, within the image, a local region that includes at least part of a detection target that is included in the tracking target;
execute cropping-region determination processing of, based on size information of the local region, determining size information of a cropping region for cropping the tracking target from the image; and
execute cropping processing of generating a cropped image by cropping the image based on the cropping region.

2. The information processing apparatus according to claim 1,
wherein the one or more processors further execute the instructions to:
in the local-region specification processing, specify a plurality of local regions that each include at least part of a corresponding one of a plurality of types of detection targets that are included in the tracking target; and
in the cropping-region determination processing, determine size information of the cropping region based on size information of one of the plurality of local regions.

3. The information processing apparatus according to claim 2,
wherein the one or more processors further execute the instructions to
in the cropping-region determination processing, determine size information of the cropping region based on size information of a local region of a detection target selected from the plurality of types of detection targets based on predetermined priority ranks of the detection targets.

4. The information processing apparatus according to claim 1,
wherein the one or more processors further execute the instructions to:
in the local-region specification processing, specify a plurality of local regions that include at least part of the detection target of the tracking target; and
in the cropping-region determination processing, determine size information of the cropping region based on size information of the plurality of local regions.

5. The information processing apparatus according to claim 4,
wherein the one or more processors further execute the instructions to
in the cropping-region determination processing, determine size information of the cropping region based on a result obtained by executing averaging processing on size information of the plurality of local regions.

6. The information processing apparatus according to claim 4,
wherein the one or more processors further execute the instructions to
in the cropping-region determination processing, determine size information of the cropping region based on at least one of a maximum and a minimum that are set based on size information of the cropping region.

7. The information processing apparatus according to claim 1,
wherein the one or more processors further execute the instructions to:
in the local-region specification processing, specify a plurality of local regions from a plurality of images of different times; and
in the cropping-region determination processing, determine size information of the cropping region based on size information of at least one of the plurality of local regions.

8. The information processing apparatus according to claim 7,
wherein the one or more processors further execute the instructions to:
in the local-region specification processing, specify a plurality of local regions that each include at least part of a corresponding one of a plurality of types of detection targets that are included in the tracking target; and
in the cropping-region determination processing, determine size information of the cropping region based on size information of a local region of a detection target selected from the plurality of types of detection targets.

9. The information processing apparatus according to claim 8,
wherein the one or more processors further execute the instructions to
in the cropping-region determination processing, determine size information of the cropping region based on size information of a local region of a detection target selected from the plurality of types of detection targets based on a change in size information of the plurality of local regions.

10. The information processing apparatus according to claim 1,
wherein the one or more processors further execute the instructions to
in the local-region specification processing, specify a plurality of local regions that each include at least part of a corresponding one of a plurality of types of detection targets that are included in the tracking target; and
in the cropping-region determination processing, determine size information of the cropping region based on size information of a local region of a detection target selected from the plurality of types of detection targets based on a recognition accuracy of the tracking target.

11. The information processing apparatus according to claim 10,
wherein the one or more processors further execute the instructions to
in the cropping-region determination processing, use, as the recognition accuracy, at least one of a recognition rate of the tracking target and a recognition score of the tracking target.

12. The information processing apparatus according to claim 1,
wherein the one or more processors further execute the instructions to:
in the local-region specification processing, specify a plurality of local regions from a plurality of images of different times; and
in the cropping-region determination processing, determine whether or not to set a cropping region at a previous time as a current cropping region based on a change in size information of the plurality of local regions.

13. The information processing apparatus according to claim 12,
wherein the one or more processors further execute the instructions to
in the cropping-region determination processing, in a case where the local region used to determine a cropping region in an image at the previous time is undetected in a current image, set the cropping region at the previous time as a cropping region for the current image.

14. The information processing apparatus according to claim 1,
wherein the one or more processors further execute the instructions to
in the local-region specification processing, specify the local region from the cropped image and an image larger than the cropped image.

15. The information processing apparatus according to claim 1,
wherein the one or more processors further execute the instructions to
in the local-region specification processing, set a local region based on a detection target set in accordance with a category of tracking target.

16. The information processing apparatus according to claim 1,
wherein the one or more processors further execute the instructions to
acquire the image that is input;
set the tracking target;
execute a plurality of recognition tasks on the tracking target in the cropped image; and
in the tracking-target specification processing, specify the tracking target included in the image based on results of the plurality of recognition tasks.

17. An information processing method comprising:
specifying, as a tracking target, a target to be tracked that is included in an image;
specifying, within the image, a local region that includes at least part of a detection target that is included in the tracking target;
based on size information of the local region, determining size information of a cropping region for cropping the tracking target from the image; and
generating a cropped image by cropping the image based on the cropping region.

18. A non-transitory computer-readable storage medium storing a computer program that, when read and executed by a computer, causes the computer to function as:
a tracking-target specification unit configured to specify, as a tracking target, a target to be tracked that is included in an image;
a local-region specification unit configured to specify, within the image, a local region that includes at least part of a detection target that is included in the tracking target;
a cropping-region determination unit configured to, based on size information of the local region, determine size information of a cropping region for cropping the tracking target from the image; and
a cropping unit configured to generate a cropped image by cropping the image based on the cropping region.
